(19) United States
(12) Patent Application Publication
(10) Pub. No.: US 2026/0184437 A1
(43) Pub. Date: Jul. 2, 2026

(54) AIRCRAFT INFLIGHT ENTERTAINMENT SERVER PROVIDING LANGUAGE TRANSLATION OF ANNOUNCEMENTS

(71) Applicant: Thales Avionics, Inc., Irvine, CA (US)

(72) Inventor: Nicolas FLOQUET, Martignas-sur-Jalle (FR)

(21) Appl. No.: 19/069,857

(22) Filed: Mar. 4, 2025

Related U.S. Application Data
(60) Provisional application No. 63/739,951, filed on Dec. 30, 2024.

(51) Int. Cl. B64D 45/00; B64D 11/00; G06F 40/58; H04N 21/214; H04N 21/258; H04N 21/485

(52) U.S. Cl. CPC B64D 45/0005; B64D 11/00155; G06F 40/58; H04N 21/2146; H04N 21/25891; H04N 21/4856; B64D 2045/007; B64D 2045/0085

(57) ABSTRACT

Various embodiments of the present disclosure are directed to an inflight entertainment computer server. The IFE computer server includes at least one network interface, at least one processor connected to communicate through the at least one network interface with video display units and/or personal electronic devices, and at least one memory. The at least one memory including a language conversion module operative to translate an announcement including digitized speech and/or text from a first language to an available set of translated languages; a passenger preferred language module operative to identify a set of passenger preferred languages based on information obtained for passengers onboard the aircraft; and an announcement distribution module operative to receive the announcement in the first language generated by a crew member or by a controller, and process the announcement in the first language through the language conversion module to output a set of translated announcements.

### CROSS REFERENCE TO RELATED APPLICATIONS

This application claims the benefit of U.S. Provisional Patent Application Ser. No. 63/739,951 filed on Dec. 30, 2024, the disclosure and content of which is incorporated by reference herein in its entirety.

### TECHNICAL FIELD

The present disclosure relates to providing notifications through aircraft and other vehicle environments.

### BACKGROUND

Announcements by airline crew to passengers in aircraft cabins are primarily audio-based, making them unintelligible to individuals who speak a different language. Crew members attempt to manage this problem by repeating announcements in more than one language. However, there is a practical limitation as to the availability of multi-lingual crew members on such flights and the amount of multi-language repetition which passengers and crew will find acceptable.

### SUMMARY

Various embodiments of the present disclosure are directed to an aircraft inflight entertainment (IFE) computer server. The IFE computer server includes at least one network interface; at least one processor connected to communicate through the at least one network interface with video display units (VDUs) and/or personal electronic devices (PEDs); and at least one memory. The at least one memory includes modules. A language conversion module that is operative to translate an announcement including digitized speech and/or text from a first language to an available set of translated languages. A passenger preferred language module is operative to identify a set of passenger preferred languages based on information obtained for passengers onboard an aircraft and served by the IFE computer server. An announcement distribution module is operative to receive the announcement in the first language generated by a crew member or by a controller, and to process the announcement in the first language through the language conversion module to output a set of translated announcements with each corresponding to a different one of the set of passenger preferred languages. The announcement distribution module is further operative to, for each of the passengers who have a preferred language that is different from the first language of the announcement, identify a VDU and/or PED associated with a passenger and route through an aircraft cabin network one of the translated announcements in a passenger preferred language of the passenger to the VDU and/or PED associated with the passenger.

Some other related embodiments are directed to a method performed by an IFE computer server. The method includes receiving an announcement including digitized speech and/or text in a first language generated by a crew member or by a controller. The method processes the announcement, through a language conversion module, in the first language to output a set of translated announcements each corresponding to a different one of the set of passenger preferred languages. The method translates, through the language conversion module, the announcement from one language to an available set of translated languages. The method identifies a set of passenger preferred languages based on information obtained for passengers onboard an aircraft and served by the IFE computer server. For each of the passengers who have a preferred language that is different from the first language of the announcement, the method identifies a VDU and/or PED associated with a passenger and routes through an aircraft cabin network one of the translated announcements in a passenger preferred language of the passenger to the VDU and/or PED associated with the passenger.

Some other related embodiments are directed to a non-transitory computer-readable storage medium, having stored thereon a computer program, including instructions which, when executed on at least one processor, cause the at least one processor to carry out operations. The operations receive an announcement including digitized speech and/or text in a first language generated by a crew member or by a controller. The operations process the announcement, through a language conversion module, in the first language to output a set of translated announcements each corresponding to a different one of the set of passenger preferred languages. The operations translate, through the language conversion module, the announcement from one language to an available set of translated languages. The operations identify a set of passenger preferred languages based on information obtained for passengers onboard an aircraft and served by the IFE computer server. For each of the passengers who have a preferred language that is different from the first language of the announcement, the operations identify a VDU and/or PED associated with a passenger and route through an aircraft cabin network one of the translated announcements in a passenger preferred language of the passenger to the VDU and/or PED associated with the passenger.

Other IFE computer servers, methods, and non-transitory computer-readable storage mediums according to embodiments of the present disclosure will be or become apparent to one with skill in the art upon review of the following drawings and detailed description. Moreover, it is intended that all embodiments disclosed herein can be implemented separately or combined in any way and/or combination.

### BRIEF DESCRIPTION OF THE DRAWINGS

The accompanying drawings, which are included to provide a further understanding of the disclosure and are incorporated in and constitute a part of this application, illustrate certain non-limiting embodiment(s) of the invention. In the drawings:

FIG. 1 illustrates a simplified system block diagram of an IFE system including an IFE server configured to provide translated announcements in a passenger preferred language, according to some embodiments;

FIG. 2 illustrates a simplified system block diagram of the IFE server of FIG. 1 that is configured to process an announcement in the form of input digitized speech and/or text, translate the announcement to a set of translated languages, and route at least one of the translated announcements to a VDU and/or PED of a passenger, according to some embodiments; and

FIG. 3 illustrates an example of a machine learning model that is trained to associate input digitized speech and/or text to generate the digitized speech and/or text into a plurality of the available set of translated languages, according to some embodiments.

### DETAILED DESCRIPTION

In the following detailed description, numerous specific details are set forth in order to provide a thorough understanding of aspects of the invention. However, it will be understood by those skilled in the art that the present invention may be practiced without these specific details. In other instances, well-known methods, procedures, components and circuits have not been described in detail so as not to obscure the present invention.

Although various embodiments are explained herein in the context of translating an announcement and routing a translated announcement to a passenger in an inflight entertainment (IFE) environment of an aircraft for display to passengers, other embodiments are not limited thereto and may be used with other types of vehicles, including, without limitation, ships (e.g., cruise ships), buses, and trains, and non-vehicle environments (e.g., broadcast television, streaming video services, audio announcement systems, etc.). Accordingly, embodiments are not limited for use with passengers but may instead be used for any persons who have hearing impairment or prefer to view announcements in a language other than the one used in the initial announcement. The terms announcements and notifications are used interchangeably and can have the same meaning herein.

Some embodiments of the present disclosure are directed to addressing a longstanding issue related to providing passenger announcements within an aircraft cabin and how to make such announcements accessible and acceptable to passengers that speak a different language or are deaf passenger(s). The term deaf passenger(s) is used herein to refer to any person with a hearing impairment that makes it more difficult to hear audible announcements. The technical challenge arises from the lack of effective communication and situational awareness for passengers on flights that do not understand the announcements made due to inability to understand the language(s) of in-flight announcements.

Currently, the majority of passenger announcements in aircraft cabins are conveyed through audio messages played via the aircraft's loudspeakers and headphone interfaces. These announcements fall into various categories, including Passenger Announcements (PA), Pre-Recorded Announcements (PRAM), and Video Announcements (typically for safety videos). The announcements can cover a large range of topics, for example, superficial information such as duty-free shopping related, to messages that can impact the passenger traveling experience (connecting flight information, delay notification) or even impact the passenger safety (turbulence notification). Passengers who do not speak the language of the announcement and deaf passengers, however, receive limited information from these announcements, typically relying on visual cues such as cabin signs or video announcements with closed captions in one or more written languages, if available.

Using live audio for such messages can have major drawbacks including being unsuitable for hearing impaired passenger, unsuitable for passengers that don't understand the announcement language, and can be missed by passengers in many situations (e.g., passenger is sleeping, distracted by conversation with other passenger, or distracted by viewing content).

Various embodiments are directed to enhancing communication and situational awareness for passengers by an IFE server translating announcements in the form of digital speech and/or text to a preferred language(s) of the passenger(s) and routing the translated announcements to the passengers for their viewing in text form.

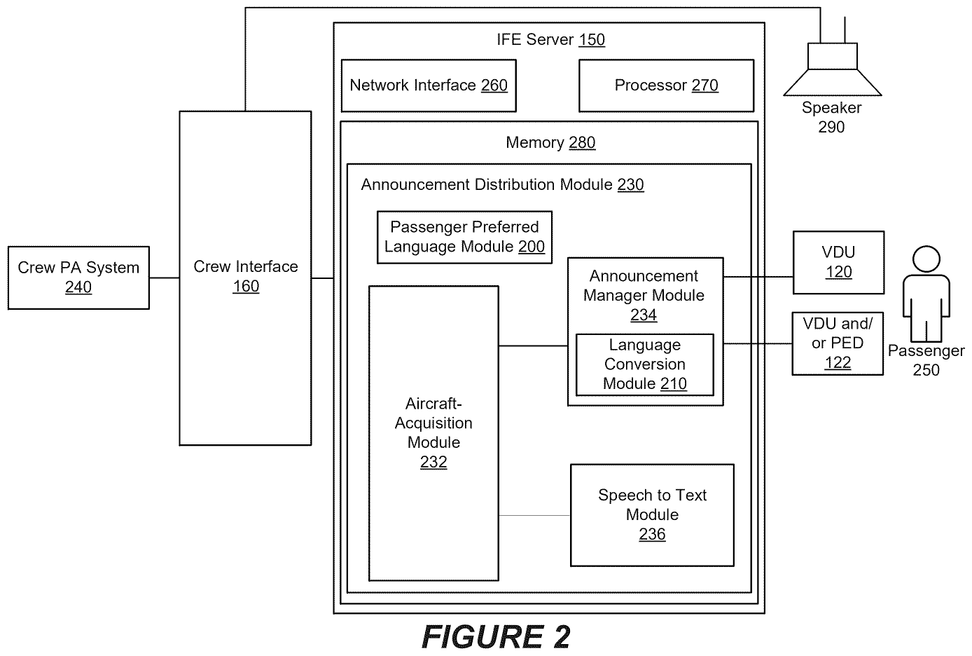

In some embodiments, the IFE server uses an aircraft acquisition module and announcement management module (described further with reference to FIG. 2) and connects it to a live STT (Speech-to-text) artificial intelligence (AI) based service to generate one or more translated announcements. All translated announcements are then stored, and exposed to passengers through interfaces such as a representational state transfer (REST) application programming interface (API). In some embodiments, this is performed live as the announcement is being projected through a speaker to the rest of the passengers. In other embodiments, there is a predefined delay to the translation and/or routing of the translated announcement to the passenger(s), or the translated announcements are provided to the passengers upon a request made by the passenger using the passenger's VDU and/or PED.

The announcements may be used to notify passengers of events and crew initiated messages such as: shopping, promotion of an airline credit card, aircraft doors closing; aircraft doors opening; initiation of taxiing and takeoff procedure; initiation of approach and landing procedure; initiation of taxiing and takeoff procedure; initiation of approach and landing procedure; activation of a fasten seatbelt sign; anticipated turbulence; deactivation of the fasten seatbelt sign; depressurization of the aircraft cabin; etc.

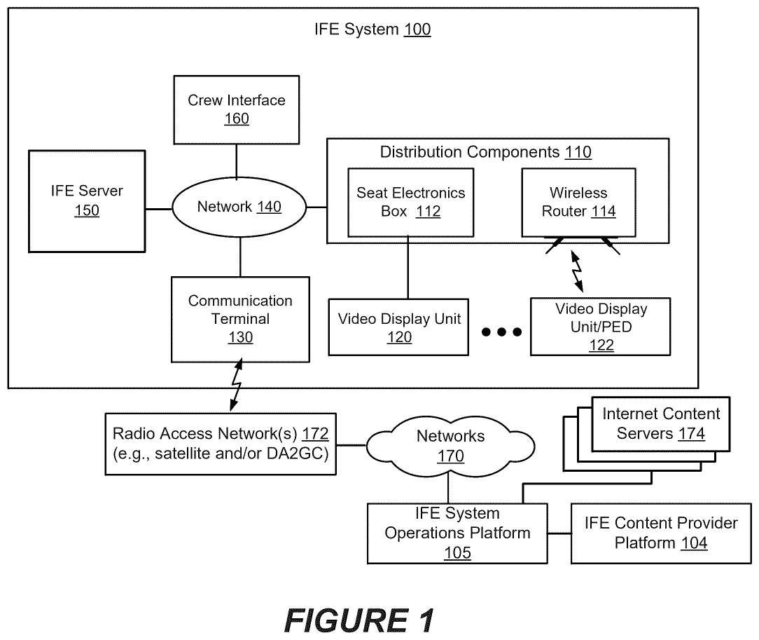

FIG. 1 illustrates a simplified system block diagram of an IFE system 100 configured to provide translated announcements in a passenger preferred language, according to some embodiments.

Referring to FIG. 1, the IFE system 100 includes video display units (VDUs) 120 and VDUs and/or personal electronic devices (PEDs) 122 that communicate through communication distribution components 110 with an IFE server 150 and communication terminal 130. Some VDUs communicate through wired networks (e.g., ethernet) via seat electronics boxes 112, and other VDUs and/or PEDs 122 communicate through wireless router(s) 114, such as WiFi access point and/or cellular access point (e.g., a pico-cell radio base station) of distribution components 110. The VDUs can include, without limitation, seat displays which are mounted to individual seats, e.g., seatbacks or armrests. Example PEDs 122 are transportable onto the aircraft can include, without limitation, smart phones, tablet computers, laptop computers, gaming computers, etc.

The PEDs can be communicatively connected with the IFE server 150, for example, using WiFi communications routed through the wireless router 114 and/or using Bluetooth communications routed through Bluetooth pairings between PEDs and VDUs 120.

The IFE server 150 can provide broadcast and/or on-demand distribution of passenger-requested content to passengers. The IFE server 150 may receive announcements from a crew interface 160, cockpit equipment, and/or an aircraft notification interface (e.g., connected to an aircraft interface converter) through network 140. The communication terminal 130 can communicate through satellite networks with ground-based radio access network(s) 172 (e.g., ground relays) and may through direct-air-to-ground communications (DA2GC) communicate with cellular 3GPP NR 5G base stations (e.g., eNodeBs, gNodeBs, etc.), etc. In some optional embodiments, the IFE system 100 communicates through the wireless networks 170 with an IFE system operations platform 105 which controls access to content from an IFE content provider platform 104 and/or other networked content servers such as Internet content servers 174.

The VDUs and/or PEDs can send requests to the IFE server 150 through the distribution components 110 and receive routed, translated announcements from the IFE server through the distribution components 110.

FIG. 2 illustrates a simplified system block diagram of the IFE server 150 of FIG. 1 that is configured to process an announcement in the form of input digitized speech and/or text, translate the announcement to a set of translated languages, and route at least one of the translated announcements to a VDU and/or PED of a passenger 250, according to some embodiments.

The IFE system may trigger notification and/or announcements to passengers by interfacing with an aircraft notification system (using various messaging types and protocols) or via a crew public address (PA) system 240. When a notification or announcement is triggered by the aircraft notification system or the crew PA system 240, the crew interface 160 interprets the action to be taken and broadcasts the corresponding audio to speakers 290 spaced apart in the cabin. Additionally, or alternatively, the crew PA system 240 may be used by a crew member to initiate a digital text to all or some of the VDU(s) and/or PED(s) in the airplane. For example, a crew member may type a message or select a preconfigured passenger announcement on a controller that is communicatively coupled to the crew interface 160. The typed message or selected preconfigured passenger announcement may include text to be sent to one or more VDUs and/or PEDs or is to be converted to an audio message for playing through the speakers 290. In the context of the present innovation, these audio messages (i.e., digitized speech) and/or texts are also sent to the IFE server 150.

A crew member may initiate an announcement using the crew PA system 240 and the crew interface 160 may broadcast both an audio signal and a discrete signal in compliance with ARINC-628P3. The audio signal may be transmitted to the speaker 290, and the audio signal and the discrete signal may be routed to the aircraft acquisition module 232 of the IFE server 150.

The IFE server 150 includes at least one network interface 260; at least one processor 270 connected to communicate through the at least one network interface 260 with video display units (VDUs) and/or personal electronic devices (PEDs) (e.g., VDU 120 or VDU and/or PED 122); and at least one memory 280. The at least one memory 280 includes a language conversion module 210. The language conversion module 210 is operative to translate an announcement (e.g., the audio signal sent to the aircraft acquisition module 232) including digitized speech and/or text from a first language (i.e., the language used in the announcement) to an available set of translated languages. For example, the language conversion module 210 may translate an announcement from English to a plurality of other languages including French, Spanish, Italian, Dutch, etc.

The memory 280 further includes a passenger preferred language module 200 operative to identify a set of passenger preferred languages based on information obtained for passengers onboard an aircraft and served by the IFE computer server. In some embodiments, the preferred language information obtained for passengers onboard the aircraft and served by the IFE computer server includes at least one of: information indicating language settings a passenger has selected for a user interface of the VDU and/or PED associated with the passenger, information indicating passenger defined language preference, information indicating a home country, information indicating citizenship of the passenger, etc. For example, if a passenger has selected Spanish for a language to display text on their PED, then the passenger's preferred language may include Spanish and the passenger preferred language module may add Spanish to the set of passenger preferred languages.

The passenger preferred language module 200 may identify a preferred language for each passenger onboard the aircraft or a subset of passengers onboard the aircraft. For example, the passenger preferred language module 200 may be controlled to only identify a preferred language for passengers (e.g., passenger 250) that have a VDU and/or PED that is associated with the passenger. Identifying a VDU and/or PED that is associated with a passenger is discussed in further detail below.

The memory 280 further includes an announcement distribution module 230. The announcement distribution module 230 is operative to receive an announcement in a first language generated by a crew member or by a controller. For example, the aircraft acquisition module 232 may receive the announcement and route the announcement to the announcement manager module 234 and the speech to text module 236. In some embodiments, the announcement manager module 234 of the announcement distribution module 230 is operative to detect a start and end of the announcement.

The announcement distribution module 230 is further operative to process the announcement in the first language through the language conversion module 210 to output a set of translated announcements each corresponding to a different one of the set of passenger preferred languages. For example, if the onboard passengers are determined to have 10 different language preferences, then the set of passenger preferred languages can contain all of those languages which are supported by the language conversion module 210. The language conversion module 210 can translate the announcement in the first language to each of the passenger preferred languages in the set which are different than the first language (e.g., output the announcement in 9 translated languages plus the original announcement language if the first language is in the set of 10 passenger preferred languages).

In instances in which a conversion and routing of the announcement is performed live, the announcement distribution module 230 may start and stop live speech to text processing based on the detected start and end of the live audio stream forming the announcement.

The processing (e.g., translation) of the announcement may result in the generation of translated announcements that take the form of transcripts. In some embodiments, after the speech to text processing is stopped, the announcement manager module 234 may retrieve the transcript(s) for local storage in the IFE server 150 or elsewhere onboard the aircraft. However, the transcripts may be stored remotely from the aircraft to reduce capacity of the aircraft storage needed. It may be advantageous to store the transcripts on the aircraft for quicker access by the IFE server 150.

The announcement distribution module 230 is further operative to, for each of the passengers who have a preferred language that is different from the first language of the announcement, identify (e.g., network address of) a VDU and/or PED associated with a passenger and route through an aircraft cabin network one of the translated announcements in a passenger preferred language of the passenger to the VDU and/or PED associated with the passenger. The announcement distribution module 230 may identify a VDU and/or PED associated with a passenger based on a seat assignment of the passenger (e.g., in instances in which the VDU is a seat back VDU pointing at the passenger's assigned seat), information indicating a PED that is registered to the passenger (e.g., a passenger's phone that includes information indicating an owner or user of the phone), etc. After receiving the translated announcement, the VDU and/or PED may display the translated announcement in text to the passenger for the passenger to read.

In some embodiments, the announcement distribution module 230 is further operative to route the one of the translated announcements in the passenger preferred language of the passenger to the VDU and/or PED associated with the passenger in parallel with a video through the at least one network interface to the same VDU and/or PED for simultaneous display. The translated announcement may be displayed, e.g., in a pop-up window or overlaid on top of other displayed video content. This may allow for a passenger who is watching a movie to visually see the translated announcement without the movie being stopped.

The passenger preferred languages may include any number of languages. The identification of the set of passenger preferred languages may include identifying if a passenger is hearing impaired. If a passenger is identified as being hearing impaired but has a preferred language that is the same as the first language of the announcement, the announcement distribution module 230 may be further operative to treat the hearing impaired passenger as having the same language preference as the announcement if the announcement is to be displayed as text to that passenger. However, if the announcement is to be played as audio through the cabin PA speakers or through seat speaker connections, the announcement distribution module 230 may treat the hearing impaired passenger as having a preferred language that is different from the first language. For example, if the passenger's preferred language is Spanish and the first language of the announcement is Spanish but the announcement is to be played through a speaker to a hearing impaired passenger, then the announcement distribution module 230 can identify a VDU and/or PED associated with the hearing impaired passenger and route through an aircraft cabin network one of the translated announcements in the passenger preferred language (e.g., text of the announcement in Spanish or another preferred language) of the passenger to the VDU and/or PED associated with the passenger.

As used herein, the term speech includes all forms of vocalization by humans, including talking or singing.

In some embodiments, the language conversion module 210 is further operative to access a repository storing a set of preconfigured passenger announcements, each of the preconfigured passenger announcements in the set are stored in a plurality of languages corresponding to the set of translated languages, and each of the preconfigured passenger announcements in the set is stored with a likelihood value indicating likelihood that the preconfigured passenger announcement will be received during one or more of defined aircraft operational states in a set of defined aircraft operational states.

The preconfigured passenger announcements may include all anticipated types of announcements which may be broadcast to passenger during any operational state of the aircraft. The preconfigured passenger announcements may include, for example, more than 100 different types of preconfigured passenger announcements with corresponding indications in which of the defined aircraft operational states they may respectively occur. The defined aircraft operational states may include closing of aircraft doors, taxi of the aircraft, takeoff and climb to cruising altitude, turbulence, inflight emergency, cruising altitude, decent approach for landing, on-ground emergency, and opening of aircraft doors. For example, if the aircraft is presently encountering or will soon be encountering turbulence, the likelihood value will be higher for preconfigured passenger announcements that are related to fastening seatbelts, informing passengers about the turbulence, and asking the passenger to return to their seats, and would be lower for preconfigured passenger announcements that are related to duty free shopping at the destination airport.

The announcement distribution module may be operative to obtain aircraft state data from the aircraft cabin network indicating the aircraft is presently in one of a set of defined aircraft operational states when the announcement is received, and match the received announcement to one of the preconfigured passenger announcements in the set based on correlating a pattern of content of the received announcement to a pattern of content of the one of the preconfigured passenger announcements in the set and based on correlating the likelihood value indicating likelihood that the preconfigured passenger announcement will occur in the indicated present aircraft operational state. The pattern matching may include matching spectral frequency envelopes and cadence between the announcement and one of the preconfigured announcements in the set.

The repository may be stored locally on the aircraft (e.g., memory 280 or elsewhere) and accessed through the at least one network interface 260.

In some embodiments, the language conversion module comprises a machine learning model trained to associate input digitized speech and/or text to generate the digitized speech and/or text into a plurality of the available set of translated languages.

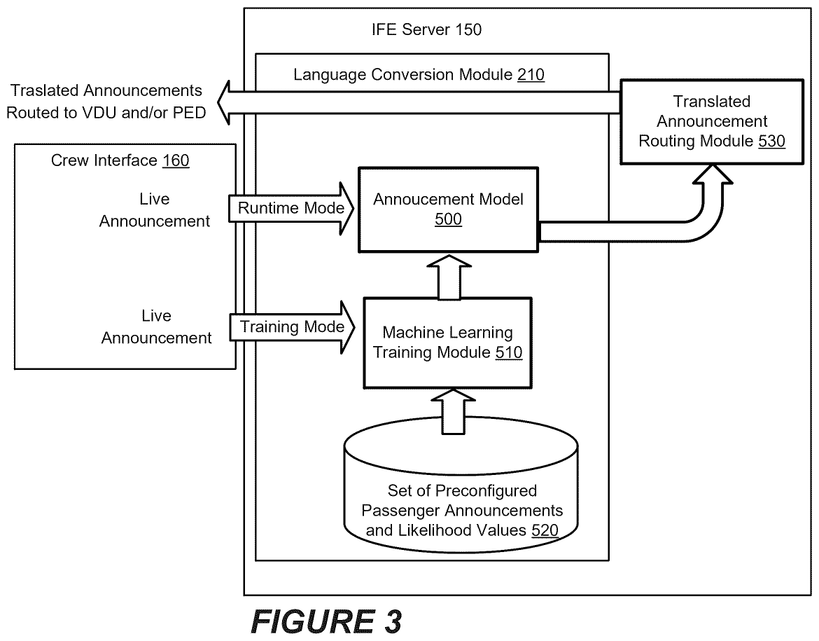

FIG. 3 illustrates an example of a machine learning model (i.e., announcement model 500) that is trained to associate input digitized speech and/or text to generate the digitized speech and/or text into a plurality of the available set of translated languages, according to some embodiments.

Referring to FIG. 3, The language conversion module 210 can include a machine learning training module 510 that operates in a training mode to train an announcement model 500 using a set of preconfigured passenger announcements 520. The set of preconfigured passenger announcements 520 can function as a repository storing a set of preconfigured passenger announcements which may include all anticipated types of announcements which may be broadcast to passenger during any operational state of the aircraft. Each of the preconfigured passenger announcements in the set 520 are stored in a plurality of languages corresponding to a set of translated languages. The set of translated languages may be selected based on information indicating which spoken languages are anticipated to be preferred by passengers throughout regions of the world where the aircraft may operate during its lifetime. Each of the preconfigured passenger announcements in the set 520 may be stored with a likelihood value indicating likelihood that the preconfigured passenger announcement will be received during one or more defined aircraft operational states in the set of defined aircraft operational states.

Accordingly, in some embodiments, the announcement model 500 can be trained using a set of preconfigured passenger announcements 520 to translate any of the defined passenger announcements from a first one of the set of translated languages to any of the other translated languages in the set of translated languages. The announcement model 500 may be further trained using a likelihood value that indicates a likelihood that a defined passenger announcement of the set of defined passenger announcements will be received during one or more of defined aircraft operational states in a set of defined aircraft operational states.

The set of defined aircraft operational states may include, for example, a plurality of: closing of aircraft doors, taxi of the aircraft, takeoff and climb to cruising altitude, turbulence, inflight emergency, cruising altitude, decent approach for landing, on-ground emergency, and opening of aircraft doors.

In this manner, the announcement model 500 can operate as a small-language model that is trained through supervised learning to recognize with high accuracy live announcements which match one or more of the preconfigured passenger announcements in the set 520. The set may include, for example, more than 100 different types of preconfigured passenger announcements with corresponding indications in which of the defined aircraft operational states they may respectively occur. The announcement model 500 may operate to translate, perhaps with lower accuracy, live announcements which do not match one or more of the preconfigured passenger announcements in the set 520. Use of a small-language model configured in this manner can substantially reduce the memory requirements and processing requirements of the computing platform operating as the IFE server 150 in accordance with embodiments disclosed herein.

During runtime mode, a live announcement from the crew interface 160 is received by and fed through the announcement model 500 along with an indication of the current operational state of the aircraft corresponding to one of the defined aircraft operational states when the announcement is received, to output a set of translated language versions of the live announcement. The announcement model 500 may match the live announcement to one of the preconfigured passenger announcements in the set 520 based on correlating a pattern of content of the live announcement to a pattern of content of the one of the preconfigured passenger announcements in the set 520 and based on correlating the likelihood value indicating likelihood that the preconfigured passenger announcement to the aircraft state data.

The announcement model 500 may include a neural network model having hierarchical layers of summing nodes with weights and firing thresholds that are trained by the machine learning training module 510 to perform the matching and correlation. Alternatively or additionally, the announcement model 500 may include program instructions that logically match patterns of content of the live announcement to patterns of contents one of the preconfigured passenger announcements in the set 520. When the matching indicates that more than one of the preconfigured passenger announcements in the set 520 are candidate matches to the live announcement, a selection among the candidates can be performed based on which of the candidates has a likelihood value indicating it has the highest likelihood of occurring in the current operational state of the aircraft relative to the likelihood of occurrence of the other candidates.

A translated announcement routing module 530 obtains indications of the preferred languages of individual ones of the passengers, and determines network addresses of seat VDUs and/or PEDs providing service to the individual passengers. For each of the passengers, the translated announcement routing module 530 obtains one of the set of translated language versions of the live announcement that corresponds to the passenger's preferred language and routes that translated language version of the live announcement to the network address of the seat VDU and/or PED providing service to that passenger.

### Further Definitions and Embodiments

In the above description of various embodiments of the present disclosure, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a non-transitory computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A non-transitory computer-readable medium may include an electronic, magnetic, optical, electromagnetic, or semiconductor data storage system, apparatus, or device. More specific examples of the computer-readable medium would include the following: a portable computer diskette, a random-access memory (RAM) circuit, a read-only memory (ROM) circuit, an erasable programmable read-only memory (EPROM or Flash memory) circuit, etc.

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present disclosure may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

1. An aircraft inflight entertainment (IFE) computer server comprising:
at least one network interface;
at least one processor connected to communicate through the at least one network interface with video display units (VDUs) and/or personal electronic devices (PEDs); and
at least one memory comprising:
a language conversion module operative to translate an announcement including digitized speech and/or text from a first language to an available set of translated languages;
a passenger preferred language module operative to identify a set of passenger preferred languages based on information obtained for passengers onboard an aircraft and served by the IFE computer server; and
an announcement distribution module operative to:
receive the announcement in the first language generated by a crew member or by a controller;
process the announcement in the first language through the language conversion module to output a set of translated announcements each corresponding to a different one of the set of passenger preferred languages; and
for each of the passengers who have a preferred language that is different from the first language of the announcement, identify a VDU and/or PED associated with a passenger and route through an aircraft cabin network one of the translated announcements in a passenger preferred language of the passenger to the VDU and/or PED associated with the passenger.

2. The IFE computer server of claim 1, wherein:
the language conversion module comprises a machine learning model trained to associate input digitized speech and/or text to generate the digitized speech and/or text into a plurality of the available set of translated languages.

3. The IFE computer server of claim 2, wherein the machine learning model is trained using a set of preconfigured passenger announcements to translate any of the preconfigured passenger announcements from a first one of the set of translated languages to any of the other translated languages in the set of translated languages.

4. The IFE computer server of claim 3, wherein the machine learning model is further trained using a likelihood value that indicates a likelihood that a preconfigured passenger announcement of the set of preconfigured passenger announcements will be received during one or more of defined aircraft operational states in a set of defined aircraft operational states.

5. The IFE computer server of claim 1, wherein:
the language conversion module is operative to access a repository storing a set of preconfigured passenger announcements, each of the preconfigured passenger announcements in the set are stored in a plurality of languages corresponding to the set of translated languages, and each of the preconfigured passenger announcements in the set is stored with a likelihood value indicating likelihood that the preconfigured passenger announcement will be received during one or more of defined aircraft operational states in a set of defined aircraft operational states.

6. The IFE computer server of claim 5, wherein:
the announcement distribution module is further operative to:
obtain aircraft state data from the aircraft cabin network indicating the aircraft is presently in one of a set of defined aircraft operational states when the announcement is received, and
match the received announcement to one of the preconfigured passenger announcements in the set based on correlating a pattern of content of the received announcement to a pattern of content of the one of the preconfigured passenger announcements in the set and based on correlating the likelihood value indicating likelihood that the preconfigured passenger announcement will occur in the indicated present aircraft operational state.

7. The IFE computer server of claim 5, wherein the set of defined aircraft operational states comprises a plurality of closing of aircraft doors, taxi of the aircraft, takeoff and climb to cruising altitude, turbulence, inflight emergency, cruising altitude, decent approach for landing, on-ground emergency, and opening of aircraft doors.

8. The IFE computer server of claim 1, wherein the information obtained for passengers onboard the aircraft and served by the IFE computer server comprises at least one of information indicating language settings a passenger has selected for a user interface of the VDU and/or PED associated with the passenger, information indicating a home country, and information indicating citizenship of the passenger.

9. The IFE computer server of claim 1, wherein the announcement distribution module is further operative to route the one of the translated announcements in the passenger preferred language of the passenger to the VDU and/or PED associated with the passenger in parallel with a video through the at least one network interface to the same VDU and/or PED for simultaneous display.

10. A method performed by an aircraft inflight entertainment (IFE) computer server, the method comprising:
receiving an announcement including digitized speech and/or text in a first language generated by a crew member or by a controller;
processing the announcement, through a language conversion module, in the first language to output a set of translated announcements each corresponding to a different one of the set of passenger preferred languages;
translating, through the language conversion module, the announcement from one language to an available set of translated languages;
identifying a set of passenger preferred languages based on information obtained for passengers onboard an aircraft and served by the IFE computer server; and
for each of the passengers who have a preferred language that is different from the first language of the announcement, identifying a VDU and/or PED associated with a passenger and routing through an aircraft cabin network one of the translated announcements in a passenger preferred language of the passenger to the VDU and/or PED associated with the passenger.

11. The method of claim 10, further comprising:
training a machine learning model to associate input digitized speech and/or text to generate the digitized speech and/or text to a plurality of the available set of translated languages.

12. The method of claim 11, wherein the machine learning model is trained using a set of preconfigured passenger announcements to translate any of the preconfigured passenger announcements from a first one of the set of translated languages to any of the other translated languages in the set of translated languages.

13. The method of claim 12, wherein the machine learning model is further trained using a likelihood value that indicates a likelihood that a preconfigured passenger announcement of the set of preconfigured passenger announcements is to occur in a present aircraft operational state.

14. The method of claim 10, further comprising:
accessing a repository storing a set of preconfigured passenger announcements, each of the preconfigured passenger announcements in the set stored in a plurality of languages corresponding to the set of translated languages, and each of the preconfigured passenger announcements in the set is stored with a likelihood value indicating likelihood that the preconfigured passenger announcement will be received during one or more of defined aircraft operational states in a set of defined aircraft operational states.

15. The method of claim 14, further comprising:
obtaining aircraft state data from the aircraft cabin network indicating the aircraft is presently in one of a set of defined aircraft operational states when the announcement is received, and
matching the received announcement to one of the preconfigured passenger announcements in the set based on correlating a pattern of content of the received announcement to a pattern of content of the one of the preconfigured passenger announcements in the set and based on correlating the likelihood value indicating likelihood that the preconfigured passenger announcement will occur in the indicated present aircraft operational state.

16. The method of claim 14, wherein the set of defined aircraft operational states comprises a plurality of closing of aircraft doors, taxi of the aircraft, takeoff and climb to cruising altitude, turbulence, inflight emergency, cruising altitude, decent approach for landing, on-ground emergency, and opening of aircraft doors.

17. The method of claim 10, wherein the information obtained for passengers onboard the aircraft and served by the IFE computer server comprises at least one of information indicating language settings a passenger has selected for a user interface of the VDU and/or PED associated with the passenger, information indicating a home country, and information indicating citizenship of the passenger.

18. The method of claim 10, further comprising:
routing the one of the translated announcements in the passenger preferred language to the VDU and/or PED associated with the passenger in parallel with a video to the same VDU and/or PED for simultaneous display.

19. A non-transitory computer-readable storage medium, having stored thereon a computer program, comprising instructions which, when executed on at least one processor, cause the at least one processor to carry out operations comprising:
receiving an announcement including digitized speech and/or text in a first language generated by a crew member or by a controller;
processing the announcement, through a language conversion module, in the first language to output a set of translated announcements each corresponding to a different one of the set of passenger preferred languages;
translating, through the language conversion module, the announcement from one language to an available set of translated languages;
identifying a set of passenger preferred languages based on information obtained for passengers onboard an aircraft and served by an IFE computer server; and
for each of the passengers who have a preferred language that is different from the first language of the announcement, identifying a VDU and/or PED associated with a passenger and routing through an aircraft cabin network one of the translated announcements in a passenger preferred language of the passenger to the VDU and/or PED associated with the passenger.
